(19) United States
(12) Patent Application Publication
(10) Pub. No.: US 2021/0070249 A1
(43) Pub. Date: Mar. 11, 2021

(54) VEHICLE ANTI-THEFT DEVICE

(71) Applicant: Nahav 2017 Ltd., Ashkelon (IL)

(72) Inventor: Dani Yechiel BEL, Ashkelon (IL)

(21) Appl. No.: 16/959,454

(22) PCT Filed: Jan. 3, 2019
(86) PCT No.: PCT/IL2019/050013

§ 371 Date: Jul. 1, 2020

Related U.S. Application Data
(60) Provisional application No. 62/614,428, filed on Jan. 7, 2018.

(51) Int. Cl. B60R 25/06; B60R 25/20

(52) U.S. Cl. CPC B60R 25/06; B60R 25/20

(57) ABSTRACT

An anti-theft device for a car or other vehicle comprising an axle-locking mechanism (ALM) having a movable fork device, contained within a housing, and in turn the housing is coupled to the vehicle body, mounted on the vehicle chassis, for example the floor of the vehicle. The fork device extends to interlock with the axle, thereby immobilizing the vehicle. The interlocking may occur either with indentations formed on the axle, or via a set of protrusions welded to the circumferential surface of an axle, or otherwise appended to an axle. The ALM can be configured to interlock on one of the front axle, the back axle, and the drive shaft, i.e., the three places to make these things happen, which are three (3) possible locations for the interlocking. The fork movement ranges from disengaged to fully engaged, with the interlocking and engagement of the fork against the surfaces of the axle. The fork movement is either swinging, perpendicular or lateral sideways movement. In another embodiment, a pair of arc-shaped brake shoes may be used to clamp against the axle on opposite sides to immobilize it.

### FIELD OF THE INVENTION

The present invention relates to an anti-theft device for a car or other vehicle and, more particularly, to a mechanism which mechanically positions a tined fork or clamp to engage or clamp onto one of the vehicle's axles to immobilize it, preventing movement of the vehicle.

### BACKGROUND OF THE INVENTION

The greatest drawback to the use of anti-car-theft devices on the market today is that most are too expensive or are too complicated for the vehicle operator. For example, vehicles may be fitted with a steering lock. It is fitted to the steering column, usually below the steering wheel. The lock is combined with the ignition switch and engaged and disengaged either by a mechanical ignition key or electronically from the vehicle's electronic control unit. This device is easily accessible and may be easily defeated. A locking bar on the steering wheel is readily accessible and could be cut through by a would-be thief.

In another prior art vehicle anti-theft device, known as the Denver boot, a wheel of the vehicle is immobilized by an external mechanical car wheel lock placed over the wheel, so as to grab it. This device is also easily accessible, and therefore can be defeated.

Thus, there is a need to provide an inexpensive device that could be easily installed in a vehicle and effectively prevent its being moved by unauthorized persons, yet requires little or no active effort on the part of the vehicle operator to deploy the device. It would be helpful if the device were not easily accessible by thieves.

### SUMMARY OF THE INVENTION

In accordance with an embodiment of the invention, there is provided a vehicle anti-theft device, configured to immobilize a vehicle axle, by preventing its rotation, thereby preventing motion of the vehicle, and making theft impossible.

In one embodiment the inventive axle-locking mechanism (ALM) comprises a movable fork device, contained within a housing, and in turn the housing is coupled to the vehicle body, mounted on the vehicle chassis, for example the floor of the vehicle. The fork device extends to interlock with the axle, thereby immobilizing the vehicle. The interlocking may occur either with indentations formed on the axle, or via a set of protrusions welded to the circumferential surface of an axle, or otherwise appended to an axle.

The inventive ALM can be configured to interlock on one of the front axle, the back axle, and the drive shaft, i.e., the three places to make these things happen, which are three (3) possible locations for the interlocking. The fork movement ranges from disengaged to fully engaged, with the interlocking and engagement of the fork against the surfaces of the axle.

The fork movement is either swinging, perpendicular or lateral sideways movement.

In another embodiment, a pair of arc-shaped brake shoes may be used to clamp against the axle on opposite sides to immobilize it.

In embodiments, the axle-locking mechanism (ALM) is disengaged by one or more of: unlocking the car;

entering a code;
disengaging mechanism via a dedicated button/actuator inside the vehicle;
inserting the key into the ignition;
starting the car, and/or releasing the handbrake.

### Definitions

WHEEL—The entire part on which a tire is mounted. The wheel includes the hub, spokes, and rim.

An AXLE that is driven by the engine or prime mover is called a drive axle. Modern front-wheel drive cars typically combine the transmission (gearbox and differential) and front axle into a single unit called a transaxle.

The DRIVE AXLE is a split axle with differential and universal joints between the two half axles. Each half axle connects to the wheel by use of a constant velocity (CV) joint which allows the wheel assembly to move freely, vertically as well as to pivot when making turns.

In a LIVE-AXLE SUSPENSION SYSTEM, the axles serve to transmit driving torque to the wheel, as well as to maintain the position of the wheels relative to each other and to the vehicle body.

In other types of suspension systems, the axles serve only to transmit driving torque to the wheels; the position and angle of the wheel hubs is an independent function of the suspension system.

### BRIEF DESCRIPTION OF THE DRAWINGS

Various embodiments are herein described, by way of example only, with reference to the accompanying drawings, wherein like numerals designate corresponding sections or elements throughout, and wherein:

FIG. 1 is a schematic top-view of the underside of a vehicle, with two fork housings mounted on the front axle of a front-wheel drive vehicle, constructed according to the principles of the present invention;

FIG. 2 is a schematic top-view of the underside of a vehicle, with two (2) fork housings mounted on the rear axle of a rear-wheel drive vehicle and or on the driveshaft, constructed according to the principles of the present invention;

FIG. 3 is a schematic perspective-view of the fork completely disengaged at 0° along a rotational axis of engagement, constructed according to the principles of the present invention;

FIG. 4 is a schematic perspective-view of the fork in the process of engagement at 45°, constructed according to the principles of the present invention;

FIG. 5 is a schematic perspective-view of the fork fully engaged at 90°, constructed according to the principles of the present invention;

FIG. 6 is a schematic axial-view of the fork fully engaged at 90°, constructed according to the principles of the present invention;

FIG. 7 is a schematic perspective-view of the fork completely disengaged along a sideways path along any one of the 3 axles, constructed according to the principles of the present invention;

FIG. 8 is a schematic perspective-view of the fork completely engaged along a sideways path along any one of the 3 axles, constructed according to the principles of the present invention;

FIG. 9 is a schematic perspective-view of the fork completely disengaged along a perpendicular axis of extension, constructed according to the principles of the present invention;

FIG. 10 is a schematic perspective-view of the fork completely engaged along a perpendicular axis of extension, constructed according to the principles of the present invention;

FIG. 11 is a schematic perspective-view of a housing containing a pair of arc-shaped clamps (not shown) arranged to clamp against a vehicle axle, constructed according to the principles of the present invention;

FIG. 12 is a schematic perspective bottom-view of the pair of arc-shaped clamps proximate the vehicle axle, constructed according to the principles of the present invention;

FIG. 13 is a schematic straight bottom-view of the clamps of FIG. 12 shown prior to clamping the vehicle axle, constructed according to the principles of the present invention; and

FIG. 14 is a schematic straight bottom-view of the clamps of FIG. 12 shown clamped against the vehicle axle, constructed according to the principles of the present invention.

### DESCRIPTION OF THE PREFERRED EMBODIMENTS

The principles and operation of a locking mechanism for a vehicle or car, according to the present invention, may be better understood with reference to the drawings and the accompanying description.

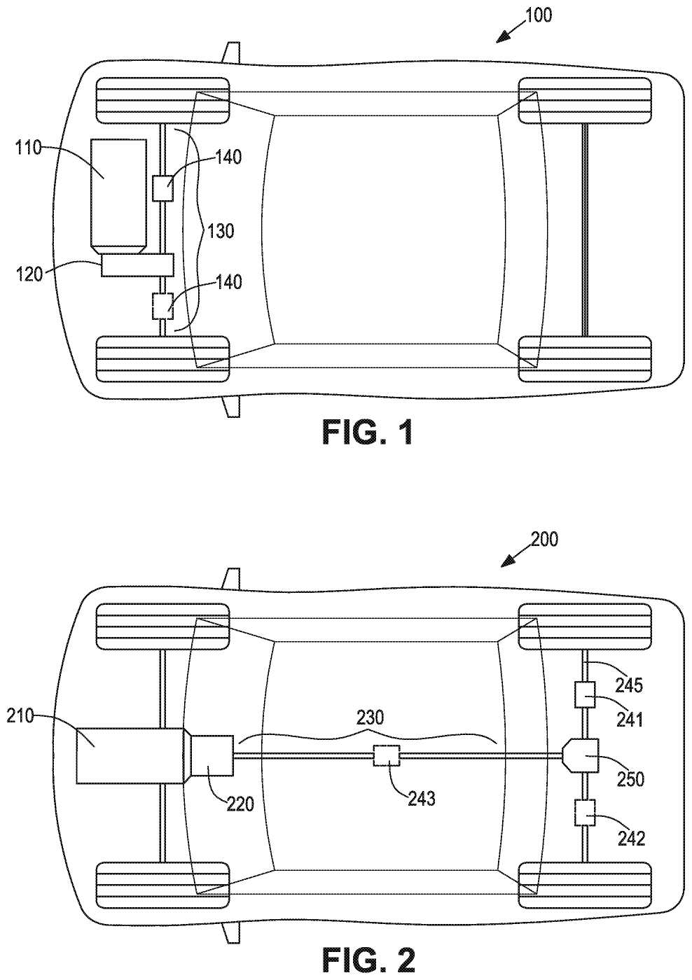

Referring now to the drawings, FIG. 1 is a schematic top-view of the underside of a front-wheel drive car 100, with the engine 110, the gearbox 120 and the fork housings 140 mounted proximate the front axle 130. The fork housings 140 are shown positioned so as to enable a fork (not shown) contained within each one to become engaged with front axle 130.

In embodiments, the mechanism of FIG. 1 includes an emergency manual override means (not shown), which is needed if for some reason the lock does not disengage automatically (e.g. an electrical fault). The lock can be manually opened with a special key by crawling under the car and manually unlocking the mechanism.

In embodiments, the locking mechanism further includes a security feature preventing manual disengaging of the electrical connection. In embodiments, the locking mechanism includes a backup battery (not shown) in the case of an electrical fault.

FIG. 2 is a schematic top-view of the underside of a rear-wheel drive car 200, with two (2) fork housings 241, 242 mounted proximate the rear axle 245, on either side of the differential 250. Alternatively, fork housing 243 may be mounted proximate the driveshaft 230. The engine 210 and the gearbox 220 are shown for reference.

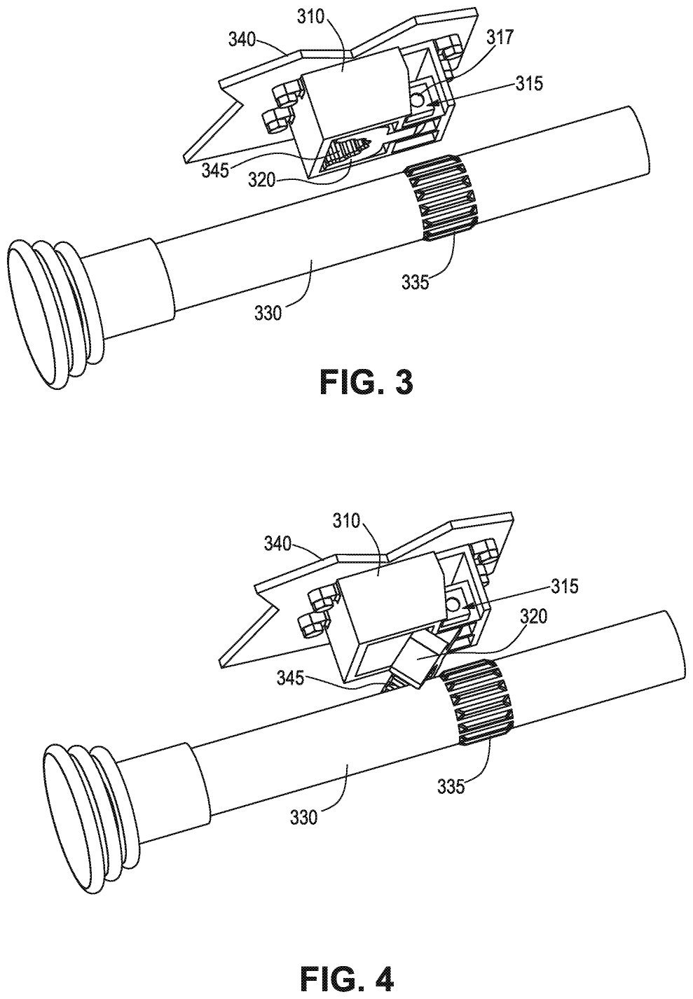

FIGS. 3, 4 and 5 show deployment of a fork 320, over protrusions 335 formed on axle 330. The fork 320 is arranged to be moved into position by an electromechanical mechanism (not shown). The following description relates to axle 330, which may be understood to represent the front axle 130, rear axle 245 or the driveshaft 230.

FIG. 3 is a schematic perspective-view of the fork 320 completely disengaged from a vehicle axle 330, at 0° along a rotational axis 317 of engagement. Fork 320 is ready to be deployed with a swinging motion around the rotational axis 317. The fork housing 310 is shown in a cutaway section, affixed to the vehicle body 340, preferably the floor of the vehicle. Axle 330 is formed or fitted with protrusions 335, which are beveled with a pyramid shape. Protrusions 335 may be added in a welded band, bolted on, or otherwise retrofitted onto axle 330, for existing cars, already in use. The band of protrusions 335 are preferably in the form of a ring around the circumference of the axle with protrusions 335 attached.

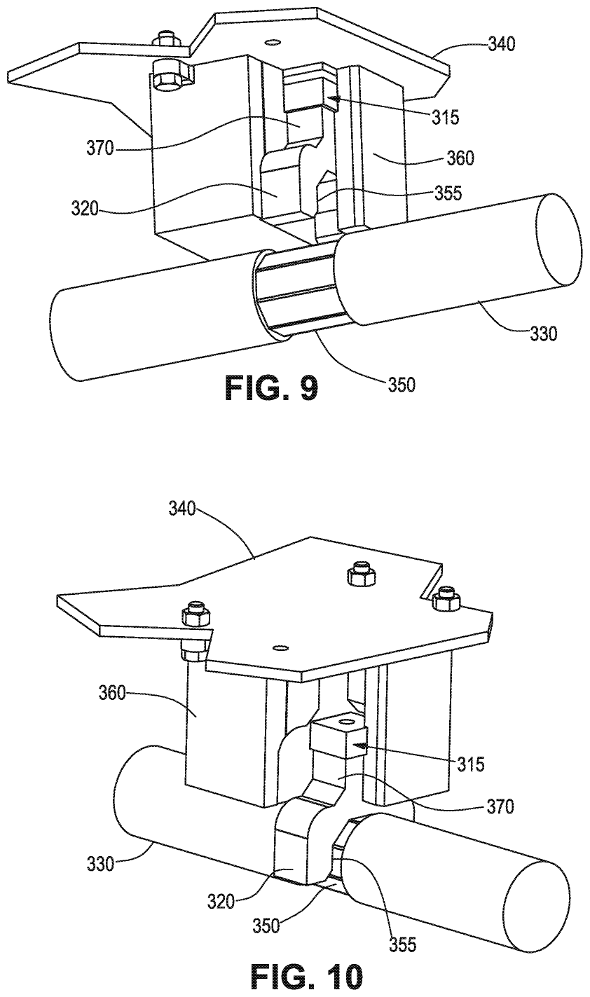

It would be easier to manufacture a car with axle indentations (see FIG. 9), which would correspond with a fork approach, as opposed to protrusions 335, which would probably be added to the axle after the initial vehicle manufacturing process.

When the fork 320 is moved into position on the axle 330 by the electro-mechanical mechanism (not shown), the axle 330 may not be in position rotationally to allow the fork 320 to slide onto the protrusions 335 on the axle 330. The fork opening, or optionally machined grooves 345 formed on the fork 320 interior, generally will not match up with the protrusions 335 on the axle 330. To overcome this alignment mismatch, an electrically-powered vibrator element 315 can be provided to assist in engagement of fork 320 with protrusions 335. Also, if the fork is moved into position properly, the next time the car is moved, the fork will slide into engagement position. In one embodiment, a battery is provided for a backup power source for the electro-mechanical mechanism. Optionally, the operation of this mechanism is automatic, or semi-automatic when the operator leaves the car standing idly or presses a button just before leaving the car.

FIG. 4 is a schematic perspective-view of the fork 320 in the process of engagement with vehicle axle 330 at 45°. The fork housing 310 is shown affixed to a cutaway section of the vehicle body 340, preferably the floor of the vehicle. Placement of fork 320 is taking place over protrusions 335.

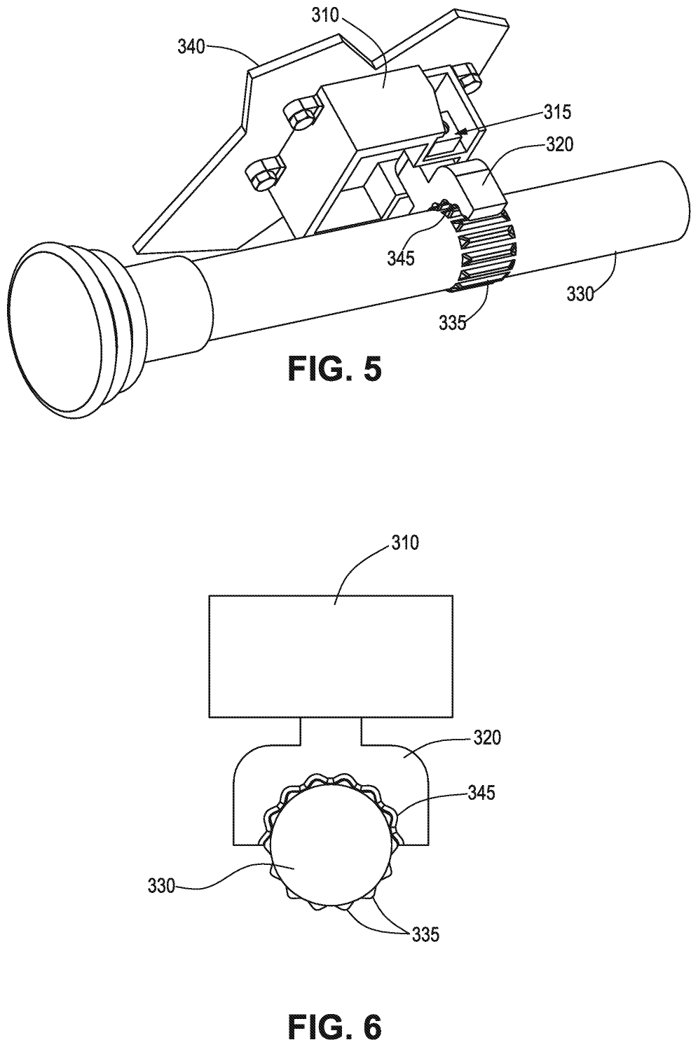

FIG. 5 is a schematic perspective-view of the fork 320 fully engaged at 90° to the electrically powered vehicle axle 330. The fork housing 310 is shown affixed to a cutaway section of the vehicle body 340, preferably the floor of the vehicle. Placement of fork 320 is positioned to engage protrusions 335, which are preferably beveled to facilitate proper alignment.

FIG. 6 is a schematic cross-sectional view of the fork 320 fully engaged at 90° to the vehicle axle 330. The fork 320 is shown extending from fork housing 310. Again, placement of fork 320 is taking place over protrusions 335.

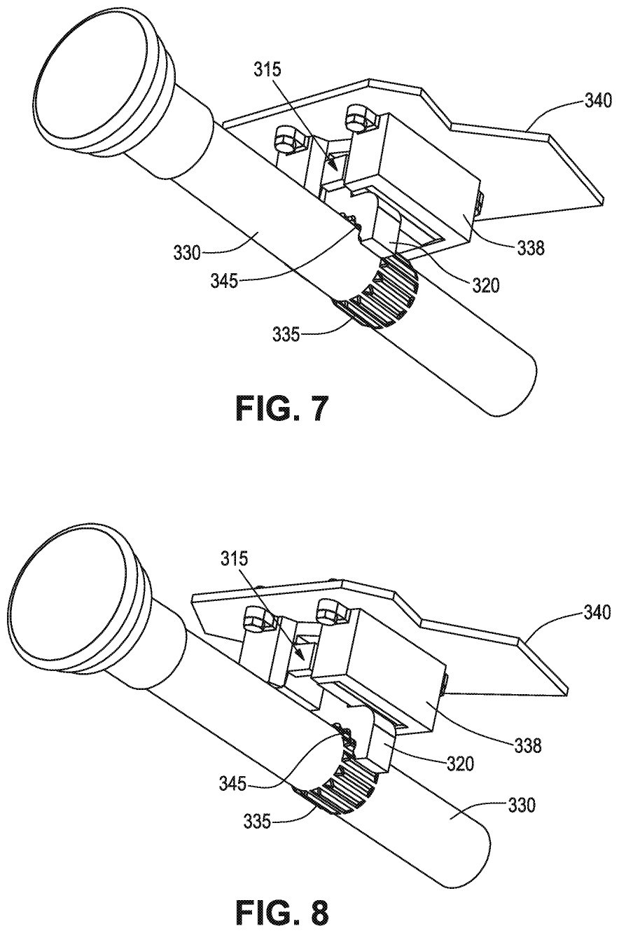

FIGS. 7-8 show deployment of the fork 320 by sideways movement along axle 330.

FIG. 7 is a schematic perspective-view of the fork 320 completely disengaged along a sideways path along any one of the 3 axles. Fork 320 is ready to be deployed sidewise along the axle 330. The fork housing 338 is shown in a cutaway section, affixed to the vehicle body 340, preferably the floor of the vehicle. Fork housing 338 is adapted for the sideways movement. Axle 330 is formed or fitted with protrusions 335. Protrusions 335 may be added in a welded band, bolted on, or otherwise retrofitted onto axle 330, for existing cars, already in use. The band of protrusions 335 is preferably in the form of a ring wrapped around the circumference of the axle 330. Also shown is a vibrator element 315 provided to assist in placement of fork 320 over protrusions 335.

FIG. 8 is a schematic perspective-view of the fork 320 completely engaged along a sideways path along any one of the 3 axles, constructed according to the principles of the present invention. The fork housing 338 is shown in a cutaway section, affixed to the vehicle body 340, preferably the floor of the vehicle. Axle 330 is formed or fitted with protrusions 335. Protrusions 335 may be added in a welded band, bolted on, or otherwise retrofitted onto axle 330, for existing cars, already in use. The band of protrusions 335 is preferably in the form of a ring wrapped around the circumference of the axle 330.

FIGS. 9-10 show deployment of a fork 320 in a perpendicular movement to axle 330 to engage with flat surfaces 350 formed as indentations on axle 330, instead of protrusions 335.

FIG. 9 is a schematic perspective-view of the fork 320 completely disengaged along an axis of extension perpendicular to the vehicle axle 330. The fork housing 360 is shown affixed to a cutaway section of the vehicle body 340, preferably the floor of the vehicle. Fork housing 360 is adapted for the perpendicular movement. Here, fork 320 is formed with machined flat surfaces 355. Placement of fork 320 is positioned to engage flat surfaces 350 formed on axle 330, with the machined flat surfaces 355 formed on fork 320, with the assistance of vibrator element 315.

In this embodiment, the axle locking mechanism comprises the fork 320 arranged to extend and retract perpendicular to the axle 330 from a fixed base or housing 360. The fork housing 360 may be permanently attached to any available area of the undercarriage. The fork is configured as a two-pronged fork providing a pincer grip that opens slightly and slides onto the flat indented surfaces 350 of axle 330, and then closes tightly on them. The width between the two prongs of the fork 320 corresponds to the transverse width between oppositely-disposed flat surfaces 350 of axle 330. The fork 320 extends and retracts on a fork rod 370. When the car is locked, or the locking mechanism is engaged (e.g. when the key is removed from the ignition, see above for additional examples), the fork 320 is extended from the housing 360 so as to engage with axle 330, so that the pincers/prongs fit onto the flat surfaces 350. The axle 330 is now locked, and the car cannot be moved.

FIG. 10 is a schematic perspective-view of the fork 320 completely engaged with the vehicle axle 330. The fork housing 360 is shown in a cutaway section, affixed to the vehicle body 340, preferably the floor of the vehicle.

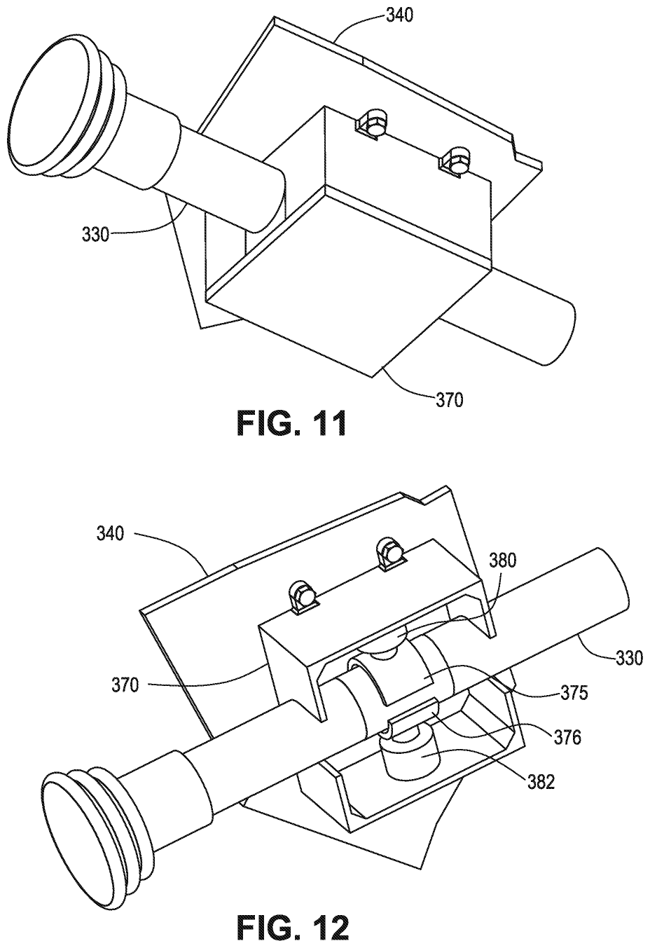

FIGS. 11-14 show another embodiment featuring the use of clamps, as opposed to a fork.

FIG. 11 is a schematic perspective-view of a housing 370 containing a pair of arc-shaped clamps (not shown) arranged to clamp against a vehicle axle 330. The clamp housing 370 is shown in a cutaway section, affixed to the vehicle body 340, preferably the floor of the vehicle. The axle 330 extends through housing 370 and has freedom of motion in a vertical direction transverse to its length.

FIG. 12 is a schematic perspective bottom-view, of housing 370, containing a pair of clamps 375, 376, completely enclosed in housing 370. Again, housing 370 is shown in a cutaway section, affixed to the vehicle body 340, preferably the floor of the vehicle.

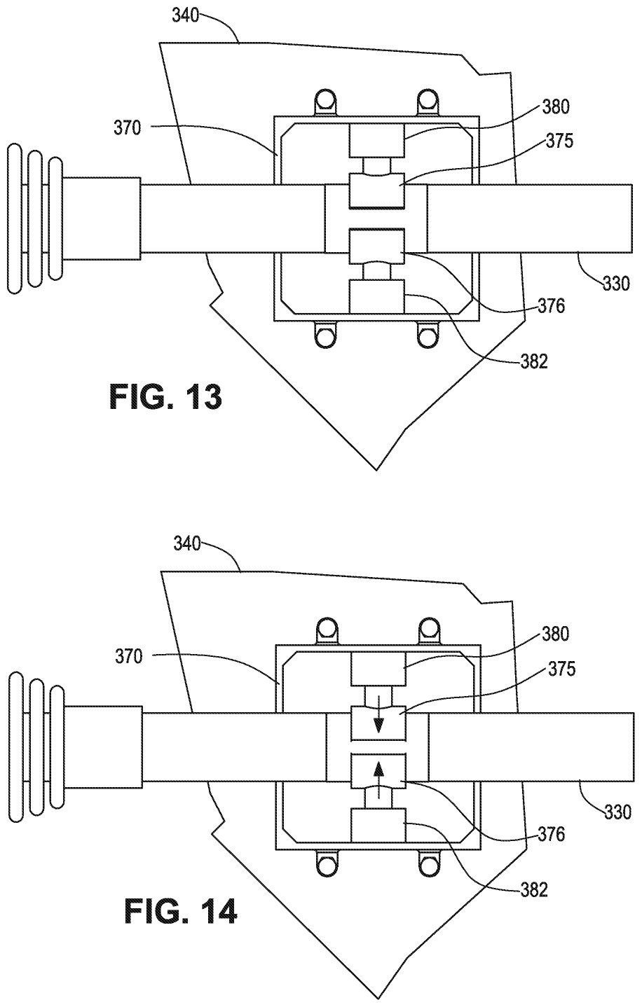

In this embodiment, the axle locking mechanism comprises a clamp-like member which extends and retracts within housing 370, using a hydraulic piston mechanism (see FIG. 13). The housing 370 may be irremovably attached to any available area of the undercarriage. In the clamp version, the clamps are configured as arc-shaped shoes that clamp onto the axle 330. When the car is locked, or the axle locking mechanism is operated (e.g. when the key is removed from the ignition, see above for additional examples), the clamps 375, 376 are extended, so as to clamp against the axle 330. The axle 330 is now locked and cannot be moved.

FIG. 13 is a schematic straight bottom-view of a pair of clamps 375 above and 376 below, in a pre-clamping position proximate vehicle axle 330. Clamps 375, 376 are mounted on hydraulic pistons 380, 382, which are completely enclosed in the housing 370.

FIG. 14 is a schematic straight bottom-view of a pair of clamps 375 and 376, in a clamped position against vehicle axle 330. Clamps 375, 376 and hydraulic pistons 380, 382 are completely enclosed in the housing 370, shown in a cutaway view. Again, the housing 370 is shown in a cutaway section, affixed to the vehicle body 340, preferably the floor of the vehicle. The downward-pointing and upward-pointing arrows represent clamping motion provided by hydraulic pistons 380 and 382, respectively.

It is made clear that the entire axle may be formed in any shape (square, hexagon, etc.) in place of being a rounded rod. Any shape of protrusions, indentations or forming of the entire axle, such that there is a place for a vise mechanism to immobilize the axle rotation, is included within the scope of the invention.

While the invention has been described with respect to a limited number of embodiments, it will be appreciated that many variations, modifications and other applications of the invention may be made. Therefore, the claimed invention as recited in the claims that follow is not limited to the embodiments described herein.

I claim:

1. A vehicle anti-theft device provided as an axle-locking system, the system comprising:
an axle interlocking means; and
mechanical positioning means coupled to said interlocking means,
wherein the system is operated to mechanically position said axle interlocking means so as to engage the vehicle axle and immobilize it, so as to prevent movement of the vehicle.

2. The device of claim 1, wherein said axle interlocking means comprises at least one of:
a fork engaged with flat indented surfaces formed in an axle of the vehicle, and
a fork engaged with protrusions provided on one of the vehicle axles,
thereby preventing axle rotation and preventing vehicular movement.

3. The device of claim 1 further comprising a housing for enclosing said axle interlocking means, wherein said axle interlocking means comprises a clamp-like member, to extend and retract within said housing and clamp against the vehicle axle.

4. The device of claim 3 wherein said clamp-like member comprises a pair of arc-shaped brake shoes to clamp against opposite sides of said axle to immobilize it.

5. The device of claim 3 wherein said housing is irremovably attached to a convenient location under said vehicle, proximate the vehicle axle.

6. The device of claim 4, wherein said convenient location for said housing is attached to any available area of the vehicle undercarriage or the vehicle chassis.

7. The device of claim 2, wherein the fork is configured as a pincer grip that slides onto said flat indented surfaces or said protrusions.

8. The device of claim 7, wherein the width between the prongs of the fork corresponds to the width between said flat indented surfaces of the vehicle axle.

9. The device of claim 1, further comprising a fork or clamp rod for extending and retracting the fork or clamp.

10. The device of claim 7, wherein when the vehicle is locked, or the locking mechanism is operated (e.g. when the key is removed from the ignition), the fork or clamp is extended from a housing, so that the pincers/prongs engage said indented flat surfaces or engage said protrusions, such that the axle is locked, and the vehicle cannot be moved.

11. The device of claim 1 wherein said axle interlocking means is disengaged by one or more of:
unlocking the car;
entering a code;
disengaging the mechanism via a dedicated button/actuator inside the vehicle;
inserting the key into the ignition; and
starting the car, and/or releasing the handbrake.

12. A method for preventing vehicle theft comprising:
providing an axle-locking system, the system comprising:
an axle interlocking means; and
mechanical positioning means coupled to said interlocking means, and
operating the system to mechanically position said axle interlocking means so as to engage the vehicle axle and immobilize it, so as to prevent movement of the vehicle.

13. The method of claim 12, wherein said axle interlocking means comprises at least one of:
a fork engaged with flat indented surfaces formed in an axle of the vehicle, and
a fork engaged with protrusions provided on one of the vehicle axles,
thereby preventing axle rotation and preventing vehicular movement.

14. The method of claim 13 wherein said fork is positioned to engage said protrusions provided on said vehicle axle by swinging motion about a rotational axis.

15. The method of claim 13 wherein said fork is positioned to engage said protrusions provided on said vehicle axle by a sideways motion along the vehicle axle.

16. The method of claim 13 wherein said fork is positioned to engage said flat indented surfaces formed in said vehicle axle by a perpendicular motion to said vehicle axle.

17. The method of claim 12 wherein said axle interlocking means comprises a clamp-like member, and said system is operated to extend and retract said clamp-like member within a housing to clamp against and immobilize the vehicle axle.
